(19) United States
(12) Patent Application Publication
(10) Pub. No.: US 2015/0339634 A1
(43) Pub. Date: Nov. 26, 2015

(54) HOME MAINTENANCE AUTOMATION

(71) Applicant: Verizon Patent and Licensing Inc, Arlington, VA (US)

(72) Inventors: Hong Xiao, Acton, MA (US); Dongchen Wang, Concord, MA (US); Azim Nasir, Foxboro, MA (US); Andre R. Turner, Belmont, MA (US)

(73) Assignee: Verizon Patent and Licensing Inc, Arlington, VA (US)

(21) Appl. No.: 14/284,966

(22) Filed: May 22, 2014

(51) Int. Cl. G06Q 10/00; G06Q 30/00; G06Q 10/10

(52) U.S. Cl. CPC G06Q 10/20; G06Q 10/1093; G06Q 30/016

(57) ABSTRACT

A network device receives customer registration information identifying a customer; receives first appliance registration information identifying a first appliance associated with the customer; and receives second appliance registration information identifying a second appliance associated with the customer. The first appliance registration information includes an initiation date and a service schedule of maintenance events for the first appliance, and the second appliance registration information includes an initiation date and a service schedule of maintenance events for the second appliance. The network device stores, in a data structure, the customer registration information, the first appliance registration information, and the second appliance registration information, and monitors the data structure for upcoming maintenance events for the first appliance or the second appliance.

### BACKGROUND

A customer may have a large number of appliances, tools, and other devices in the customer's home. For example, a customer's home may include an oven, a refrigerator, a washing machine, a furnace, a lawn mower, and/or numerous other devices. Many of these devices require maintenance, inspections, or other services on regular or irregular schedules. However, a customer may find it challenging to track service dates and proactively manage the various service schedules.

### BRIEF DESCRIPTION OF THE DRAWINGS

FIG. 1 is a diagram that depicts an exemplary network environment in which systems and methods described herein may be implemented;

FIG. 2 is a diagram of exemplary components of one of the devices of FIG. 1;

FIG. 3 is a block diagram of exemplary functional components of the mobile device of FIG. 1;

FIG. 4 is a diagram of exemplary communications, among devices in a portion of the network environment of FIG. 1, to register profiles;

FIG. 5 is a diagram of exemplary communications, among devices in another portion of the network environment of FIG. 1, to register an appliance;

FIG. 6 is a diagram of exemplary communications, among devices in a further portion of the network environment of FIG. 1, to record a service activity for an appliance;

FIG. 7 is a diagram of exemplary communications, among devices in still another portion of the network environment of FIG. 1, to order parts and/or service for an appliance;

FIGS. 8A and 8B are diagrams of exemplary user notifications capable of being generated by one of the user devices depicted in FIG. 1;

FIGS. 9A-9C are diagrams of exemplary user interfaces for responding to a service notification using one of the user devices depicted in FIG. 1;

FIG. 10 is a diagram of an exemplary user interface for a home maintenance console, according to an implementation described herein;

FIG. 11 is a diagram of exemplary communications, among devices in another portion of the network environment of FIG. 1, to consolidate service calls for a service provider;

FIG. 12 is a flow diagram that illustrates an exemplary process for monitoring customer appliance service schedules in a home maintenance automation platform, according to an implementation described herein; and

FIG. 13 is a flow diagram that illustrates an exemplary process for consolidating service calls in a home maintenance automation platform, according to an implementation described herein.

### DETAILED DESCRIPTION OF THE PREFERRED EMBODIMENTS

The following detailed description refers to the accompanying drawings. The same reference numbers in different drawings may identify the same or similar elements.

Systems and/or methods described herein provide a platform to manage maintenance and service requirements for home appliances. The systems and/or methods may utilize a maintenance client application to register home appliances, track service histories, and connect customers to service technicians and/or parts suppliers. The home appliances (or associated documents) may include a barcode tag that can be scanned by a user device (e.g., executing the client application) of customers or technicians to associate service activities with particular appliances. Backend network devices may store customer maintenance histories and allow registered service providers to see whose appliances need maintenance and promote efficiencies of localized services.

In one implementation, a network device may receive customer registration information identifying a customer. The network device may later receive appliance registration information identifying one or more appliances associated with the customer. The appliance registration information may include an initiation date and a service schedule of maintenance events for each appliance. The network device may store, in a data structure, the customer registration information and the appliance registration information, and may monitor the data structure for upcoming maintenance events for the appliances.

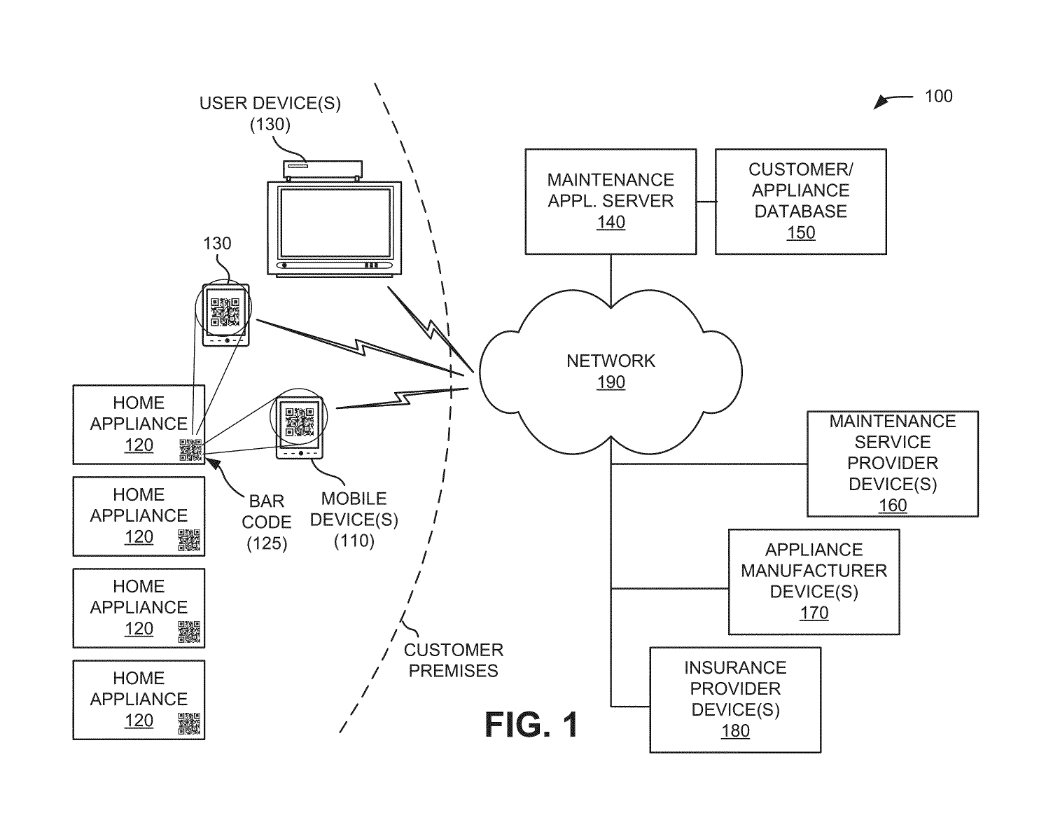

FIG. 1 is a diagram that depicts an exemplary network environment 100 in which a home maintenance automation platform may be implemented. As shown in FIG. 1, network environment 100 may include a one or more mobile devices 110, home appliances 120, user devices 130, a maintenance application server 140, a customer/appliance database 150, maintenance service provider devices 160, appliance manufacture devices 170, insurance provider devices 180, and a network 190. Components of network environment 100 may be connected via wired and/or wireless links. In one implementation, components in network environment 100 may communicate using application programming interfaces (API) to regulate interactions between devices.

Mobile device 110 may include a computation or communication device. Mobile device 110 may include a smart phone, a tablet computer, a radiotelephone, a laptop computer, a gaming console, an e-reader device, a media player, or other types of computation or communication devices. In one implementation, mobile device 110 may provide a communication interface to multiple types of networks (e.g., within network 190) including, for example, a wide area personal network (WPAN), a wireless local area network (WLAN), and/or a cellular network. Mobile device 110 may be capable of scanning and/or capturing an image of a barcode, interpreting the barcode, and accessing a remote server (e.g., maintenance application server 140) based on the barcode information. According to implementations described herein, mobile device 110 may be provided with a maintenance client application that reads and/or interrogates barcodes (e.g., barcode 125), adds updated user profile and/or service information, and transmits barcode and updated information to a backend server (e.g., maintenance application server 140).

Each of home appliances 120 may include an appliance device that may require scheduled maintenance, such as an oven, a microwave, a dishwasher, a dryer, a dishwashing machine, a refrigerator, a garage door controller, a smoke detector, an air conditioning (AC) device, a heater/furnace, a roof, or siding, small tools, and/or another type of appliance device. Each home appliance may be equipped with a barcode tag 125 that is either affixed to home appliance 120 or included in documentation for the home appliance 120.

Barcode tag 125 may include serial number, a barcode, or a quick response code included on home appliance 120 or documentation for the home appliance 120. In other implementations, barcode tag 125 may include an RFID tag or another form of electronic identification. In implementations described herein, barcode 125 may include a web service Uniform Resource Locator (URL) along with a unique appliance identifier. Mobile device 110 may read barcode tag 125 and interpret the URL. The URL may allow mobile device 110 to access a backend server (e.g., maintenance application server 140) with service information for the particular home appliance 120 associated with barcode tag 125.

Each of user devices 130 may include a mobile device or a stationary device that is capable of communicating with maintenance application server 140 and/or other devices via network 190. User device 130 may generally be used to retrieve service information and/or receive service notifications from maintenance application server 140. In one implementation, user device 130 may be the same as or similar to that of mobile device 110. In another implementation, user device 130 may include an Internet-enabled device such as a computer workstation, desktop computer, or another networked device. In still another implementation, user device may include components of a television-based communication system, such as, for example, a set-top box (STB), a home media server, a gaming console, or an Internet television. In one implementation, user device 130 may obtain data from a backend server (e.g., maintenance application server 140) via a push method or a pull method (e.g., periodically, reactively, proactively, etc.).

Maintenance application server 140 may include one or more network devices, or other types of computation or communication devices (e.g., an application server device, a mainframe computer, a personal computer, etc.), to manage maintenance inquiries (e.g., based on barcode tag readings or other communications from mobile device 110/user device 130). Maintenance application server 140 may, for example, receive registration information and/or service updates from mobile device 110. Maintenance application server 140 may associate registration information and service updates with particular user profiles to assemble a complete user record with service information for multiple appliances. User records may be stored in and retrieved from, for example, in customer/appliance database 150. In another implementation, maintenance application server 140 may query service schedules in customer/appliance database 150 to identify when maintenance/service procedures are necessary for particular customers' home appliances 120. Maintenance application server 140 may provide notifications to customers when a particular maintenance/service procedure is needed. The notifications may include a text message, an email, a television/STB pop-up notification, a notification via a mobile application (app), etc. Additionally, or alternatively, maintenance application server 140 may alert participating service providers when a particular maintenance/service procedure is needed. In one implementation, maintenance application server 140 may be associated with a telecommunication services provider that provides telecommunications services (e.g., messaging services, data services, voice services, etc.) to devices in customer premises 105. Maintenance application server 140 may also receive login requests from mobile device 110/user device 130 and/or verify credentials from mobile device 110/user device 130 before providing data to mobile device 110/user device 130.

Customer/appliance database 150 may include a database or another data structure to store data pertaining to the home maintenance automation platform. Customer/appliance database 150 may store, for example, registration information, customer profiles, and service data processed by maintenance application server 140. In one implementation, customer/appliance database 150 may include a cloud-based storage system of multiple networked devices.

Maintenance service provider devices 160 may include one or more computing devices or network devices that may communicate with maintenance application server 140 via network 190. In one implementation, maintenance service provider devices 160 may be associated with a particular business or technician that provides maintenance services for appliances 120. Maintenance service provider devices 160 may, for example, register with maintenance application server 140 to participate in the home maintenance automation platform. For example, maintenance service provider devices 160 may provide a profile of services, locations, and/or times to support home appliances 120.

Appliance manufacture devices 170 may include one or more computing devices or network devices that may communicate with maintenance application server 140 via network 190. In one implementation, appliance manufacture devices 170 may be associated with a manufacture of a particular home appliance 120. Appliance manufacture devices 170 may, for example, register with maintenance application server 140 to receive product registration and/or service information to support warranties for home appliances 120. In another implementation, appliance manufacture devices 170 may use contact information received from appliance registrations and/or maintenance application server 140 to communicate product recalls, revise service schedules, and/or update service information related to particular home appliances 120.

Insurance provider devices 180 may include one or more computing devices or network devices that may communicate with maintenance application server 140 via network 190. In one implementation, insurance provider devices 180 may be associated with an insurer of home appliances 120 and/or property that includes home appliances 120. Insurance provider devices 180 may, for example, register with maintenance application server 140 to receive product registration and/or service information to support valuations for home appliances 120.

Network 190 may include one or more networks including a cellular network, a satellite network, the Internet, a telephone network, such as the Public Switched Telephone Network (PSTN), a metropolitan area network (MAN), a wide area network (WAN), a local area network (LAN), a mesh network, or another type of network. In an exemplary implementation, communication network 190 may include a combination of networks including a cellular network that uses components for transmitting data to and from mobile device 110, user devices 130, etc. Such components may include base station antennas (not shown) that transmit and receive data from communication devices within their vicinity. Such components may also include base stations (not shown) that connect to the base station antennas and communicate with other devices, such as switches and routers (not shown) in accordance with known techniques.

In implementations described herein, mobile device 110 may download the maintenance client application and register a profile as either a consumer or a service provider. The device owner or technician can launch the maintenance client application, and press a “Scan” button to scan barcode tag 125 on home appliance 120. Mobile device 110 can send the profile information to appliance manufacturer devices 170 (e.g., either directly or via maintenance application server 140). Appliance manufacturer devices 170 may provide service information/schedules for the particular appliance to maintenance application server 140, which can be combined (e.g., by mobile device 110) with a user ID and a current date. Maintenance application server 140 may save the combined information to customer/appliance database 150, where the information may be monitored for upcoming maintenance events, such as part replacement or required service that may be needed within a particular time window (e.g., due in one month, due in two weeks, past due, etc.).

The configuration of network components of network environment 100 illustrated in FIG. 1 is for illustrative purposes only. Other configurations may be implemented. Network environment 100 may include additional, fewer, and/or different components than those depicted in FIG. 1.

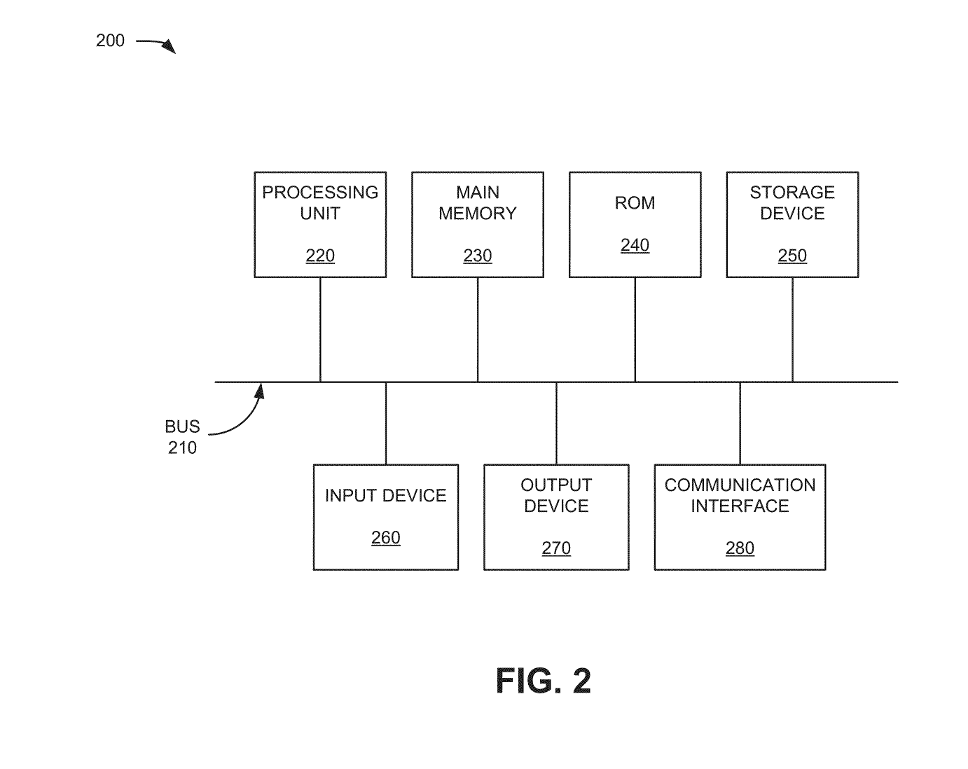

FIG. 2 is a diagram of exemplary components of a device 200. Each of user mobile device 110, user device 130, maintenance application server 140, maintenance service provider devices 160, appliance manufacture devices 170, and insurance provider devices 180 may be implemented/installed as a combination of hardware and software on one or more of device 200. Device 200 may include a bus 210, a processing unit 220, a main memory 230, a read only memory (ROM) 240, a storage device 250, an input device(s) 260, an output device(s) 270, and a communication interface 280. Bus 210 may include a path that permits communication among the elements of device 200.

Processing unit 220 may include one or more processors or microprocessors, or processing logic, which interprets and executes instructions. Main memory 230 may include a random access memory (RAM) or another type of dynamic storage device that stores information and instructions for execution by processing unit 220. ROM 240 may include a ROM device or another type of static storage device that stores static information and instructions for use by processing unit 220. Storage device 250 may include a magnetic and/or optical recording medium. Main memory 230, ROM 240, and storage device 250 may each be referred to herein as a “computer-readable medium.”

Input device 260 may include one or more mechanisms that permit a user to input information to device 200, such as, for example, a keypad or a keyboard, a display with a touch sensitive panel, voice recognition and/or biometric mechanisms, etc. Output device 270 may include one or more mechanisms that output information to the user, including a display, a speaker, etc. Communication interface 280 may include any type of transceiver that enables device 200 to communicate with other devices and/or systems. For example, communication interface 280 may include wired or wireless transceivers for communicating via network(s) 220.

As described herein, device 200 may perform certain operations in response to processing unit 220 executing software instructions stored in a computer-readable medium, such as memory 230. A computer-readable medium may include a non-transitory memory device. A memory device may be implemented within a single physical memory device or spread across multiple physical memory devices. The software instructions may be read into memory 230 from another computer-readable medium or read into memory 230 from another device via communication interface 260. The software instructions stored in memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

The configuration of components of device 200 in FIG. 2 is for illustrative purposes only. Other configurations may be implemented. Thus, device 200 may include additional, fewer and/or different components than those depicted in FIG. 2.

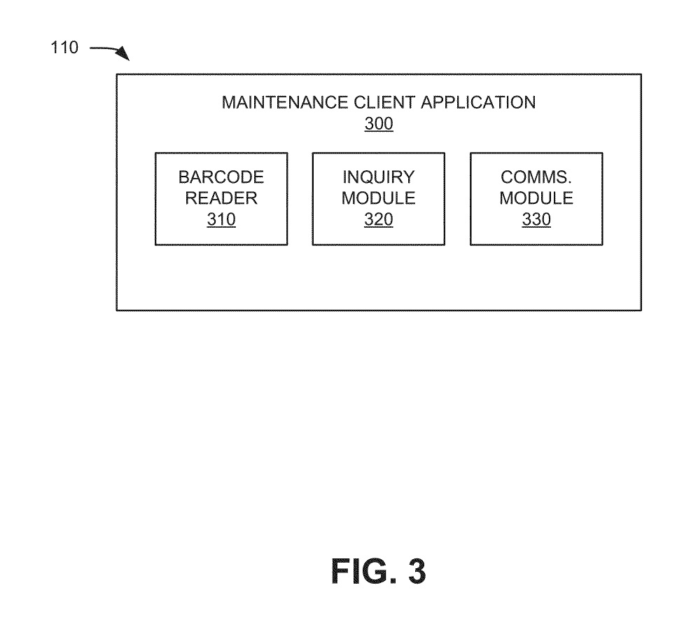

FIG. 3 is a diagram of exemplary functional components of mobile device 110. The functional component may be implemented by, for example, processing unit 220 in conjunction with memory 230. As shown in FIG. 3, mobile device 110 may include a maintenance client application 300 that includes a barcode reader 310, an inquiry module 320, and a communications module 330.

Generally, maintenance client application 300 may provide a user interface to configure mobile device 110 to read information from barcode tag 125, add user profile and/or service information, and transmit the barcode information and the user profile and/or service information to maintenance application server 140. Maintenance client application 300 may be provided to mobile device 110 from, for example, maintenance application server 140, another device via network 190, or a third-party system (e.g., a digital media store). Although described in the context of mobile device 110, maintenance client application 300 may also be included on other devices, such as user device 130.

Barcode reader 310 may work with an image processing device (e.g., a camera, scanner, etc.) of mobile device 110 to capture and interpret information from barcode tag 125. In one implementation, barcode reader 310 may detect a web service URL along with a unique appliance identifier.

Inquiry module 320 may solicit customer profile data, technician profile data, and/or service information from a user. In one implementation, inquiry module 320 may provide a user interface for a user to input requested information in response to a barcode scan. In another implementation, inquiry module 320 may send a request (e.g., a M2M request using the web service URL from barcode tag 125) to another device (e.g., appliance manufacturer device 170) to solicit a service schedule associated with a home appliance 120.

Communication module 330 may configure data obtained by inquiry module 320 and forward the data to maintenance application server 140 (or another network device). In one implementation, communication module 330 may use an IP address to conduct secure communications with maintenance application server 140.

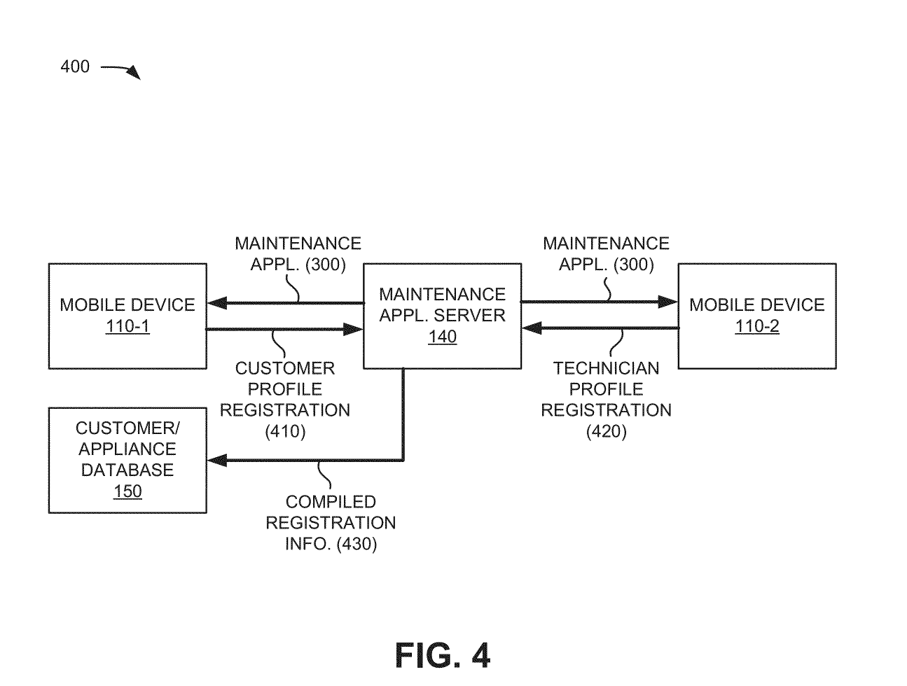

FIG. 4 is a diagram of exemplary communications among devices in a portion 400 of network environment 100. Communications in FIG. 4 may represent communications for registering a profile for the home maintenance automation platform. As shown in FIG. 4, network portion 400 may include mobile device 110, maintenance application server 140, customer/appliance database 150, maintenance service provider device 160, appliance manufacture device 170, and insurance provider device 180. Mobile device 110, maintenance application server 140, customer/appliance database 150, maintenance service provider device 160, appliance manufacture device 170, and insurance provider device 180 may include features described above in connection with, for example, FIGS. 1-3.

As shown in FIG. 4, mobile device 110-1 and mobile device 110-2 may each download maintenance client application 300. When users of mobile devices 110-1 and 110-2 launch maintenance client application 300 for the first time, maintenance client application 300 may solicit registration information from the user. In one implementation, maintenance client application 300 may request the user to select registration as either a costumer or as a service provider. Assume, the user of mobile device 110-1 may register as a customer and the user of mobile device 110-2 registers as a service provider. For registering as a customer, maintenance client application 300 may collect a customer name, home address, contact phone number(s), an email address, gender, age, etc. For registering as a service provider, maintenance client application 300 may collect a company name, location address, technician contact information, etc. In one implementation, a service technician may use maintenance client application 300 in either a customer mode or service provider mode.

Upon receiving the customer registration information, mobile device 110-1 (e.g., using maintenance client application 300) may provide customer profile registration 410 to maintenance application server 140. Similarly, upon receiving the technician registration information, mobile device 110-2 (e.g., using maintenance client application 300) may provide technician profile registration 420 to maintenance application server 140. Maintenance application server 140 may send customer profile registration 410 and technician profile registration 420 to customer/appliance database 150 as compiled registration information 430.

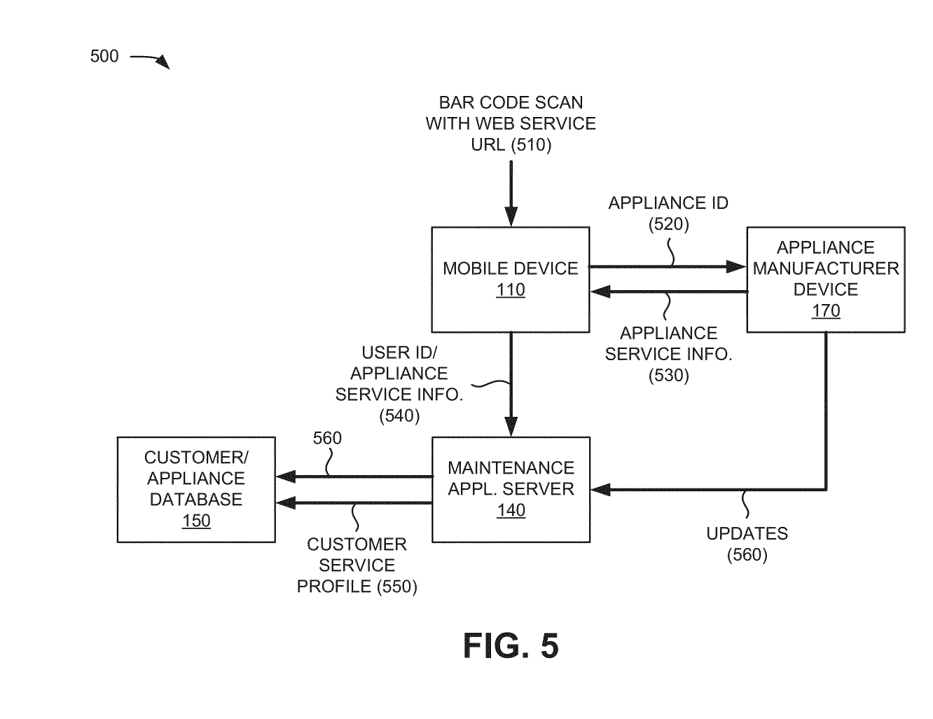

FIG. 5 is a diagram of exemplary communications among devices in a portion 500 of network environment 100. Communications in FIG. 5 may represent communications for registering a new appliance with the home maintenance automation platform. As shown in FIG. 5, network portion 500 may include mobile device 110, maintenance application server 140, customer/appliance database 150, and appliance manufacture device 170. Mobile device 110, maintenance application server 140, customer/appliance database 150, and appliance manufacture device 170 may include features described above in connection with, for example, FIGS. 1-4.

As indicated in FIG. 5, a user may use mobile device 110 (executing maintenance client application 300) to scan a barcode (e.g., barcode tag 125) on home appliance 120. The scan may provide a web service URL 510 to enable mobile device 110 to communicate with appliance manufacturer device 170. Using web service URL 510, mobile device 110 may provide an appliance identifier 520 to appliance manufacturer device 170. In one implementation, appliance identifier 520 may include a unique identifier for home appliance 120 along with user profile information. In response to appliance identifier 520, appliance manufacturer device 170 may return appliance service information 530, such as, manufacturer, model, produced date, manufacturer recommended maintenance schedule, etc. to mobile device 110. In one implementation, appliance identifier 520 and appliance service information 530 may be exchanged via machine-to-machine (M2M) communications.

As indicated by reference 540, mobile device 110 may combine a user (or device) identifier with appliance information 530 and provide the combined user identifier and appliance service information to maintenance application server 140. Maintenance application server 140 may use the information to create and/or update a customer service profile 550 for the user of mobile device 110. Customer service profile 550 may be stored in customer/appliance database 150.

According to another implementation, appliance manufacturer device 170 may initiate updates 560 to appliance service information 530. Updates 560 may include, for example, product recalls, service schedule adjustments, and the like related to particular home appliances 120. In one implementation, updates 560 to appliance service information 530 may be provided to maintenance application server 140, which may incorporate updates 560 into customer/appliance database 150. Thus, updates 560 may be detected in customer profiles when accessed by the customer or when identified during batch processing described further herein. In another implementation, updates 560 of an urgent nature (e.g., safety-related recalls) as indicated by appliance manufacturer device 170 may trigger direct communications with customers, such as an email or text notification using customer profile information.

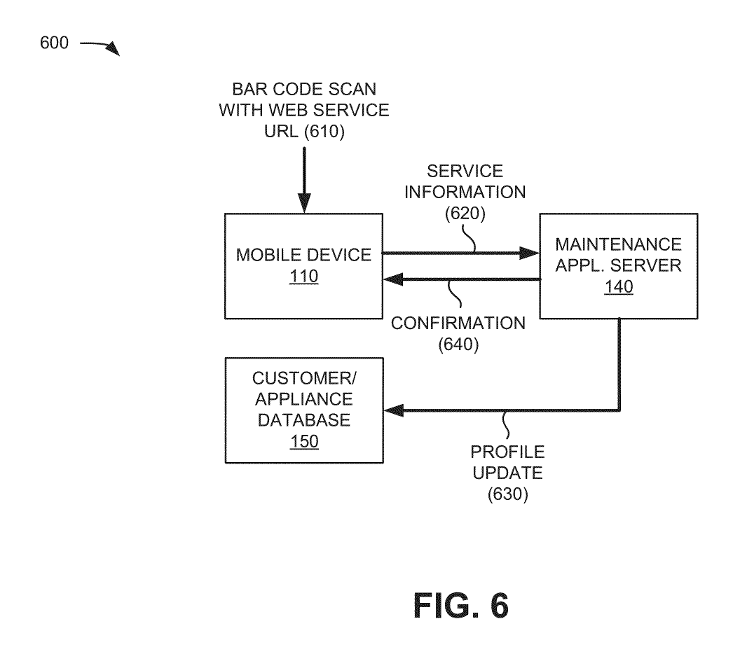

FIG. 6 is a diagram of exemplary communications among devices in a portion 600 of network environment 100. Communications in FIG. 6 may represent communications for updating a customer service record for the home maintenance automation platform. As shown in FIG. 6, network portion 600 may include mobile device 110, maintenance application server 140, and customer/appliance database 150. Mobile device 110, maintenance application server 140, and customer/appliance database 150 may include features described above in connection with, for example, FIGS. 1-5.

In initiating the communications of FIG. 6, a user (e.g., a customer or technician) may use a mobile device 110 (executing maintenance client application 300) that has previously been registered with the home maintenance automation platform, using, for example, communications described above in connection with FIG. 4. Mobile device 110 may scan a barcode (e.g., barcode tag 125) on a previously-registered home appliance 120. The scan may detect the unique appliance identifier for home appliance 120. Using information from maintenance client application 300, mobile device 110 may communicate with maintenance application server 140 to provide service information 620. Service information 620 may include, for example, a registered technician ID, the appliance identifier, a type of service, a time of service, etc. In one implementation, maintenance client application 300 may solicit details for service information 620 from the technician via a user interface. In another implementation, service information 620 may be provided to maintenance application server 140 over multiple communication steps.

Maintenance application server 140 may receive service information 620 and may processes service information 620 to provide a profile update 630 in customer/appliance database 150. Profile update 630 may update appliance maintenance records and aggregate service information for a particular home appliance 120 with other appliance information associated with the same customer. In one implementation, maintenance application server 140 may provide a confirmation 640 to mobile device 640. In one implementation, confirmation 640 may include, for example, an indication that service information has been received/processed. In another implementation, confirmation 640 may include additional information, such as a next maintenance window for the particular home appliance 120.

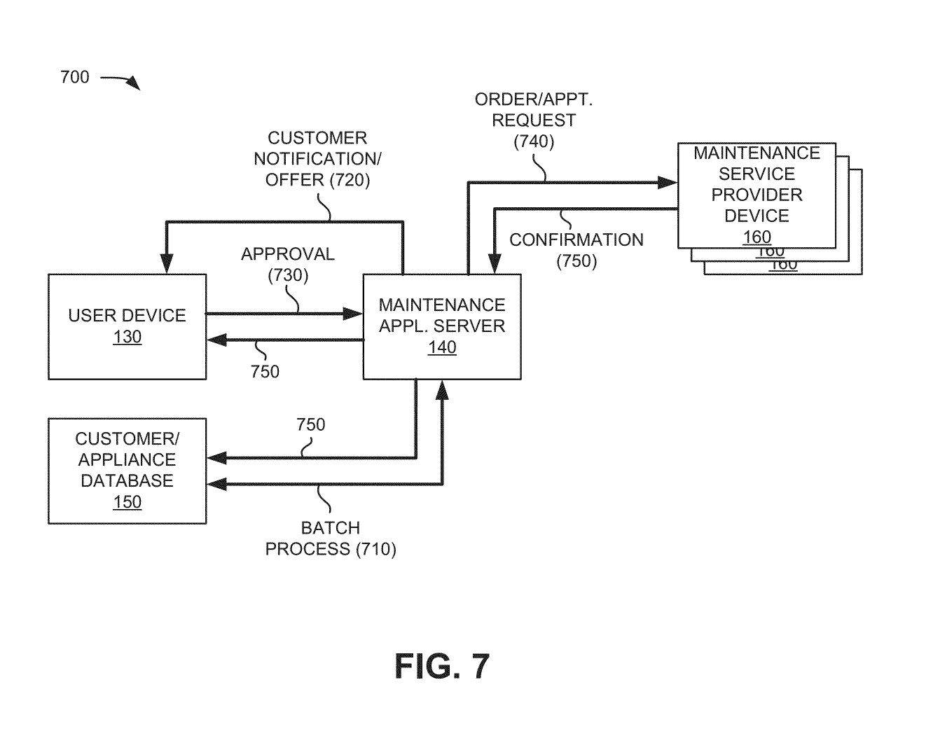

FIG. 7 is a diagram of exemplary communications among devices in a portion 700 of network environment 100. Communications in FIG. 7 may represent communications for automatic home maintenance notifications using the home maintenance automation platform. As shown in FIG. 7, network portion 700 may include user device 130, maintenance application server 140, customer/appliance database 150, and maintenance service provider device(s) 160. User device 130, maintenance application server 140, customer/appliance database 150, and maintenance service provider device(s) 160 may include features described above in connection with, for example, FIGS. 1-6.

As indicated in FIG. 7, maintenance application server 140 may conduct batch processing 710 of data in customer/appliance database 150 to calculate and aggregate customer information and to provide customer health info about their home appliances 120. Based on a batch process 710, maintenance application server 140 may detect that a scheduled maintenance event may be applicable for a home appliance 120. Maintenance application server 140 may send a customer notification/offer 720 to a user device 130 associated with home appliance 120. In one implementation, customer notification/offer 720 may include a description of a needed service (e.g., “your piano needs tuning,” “time to replace HVAC air filter,” etc.). In another implementation, customer notification/offer 720 may include an offer for one or more service providers to provide the needed service. For example, customer notification/offer 720 may include a list of participating vendors that can provide the service identified by customer notification/offer 720.

Assuming a customer elects one of the participating vendors, user device 130 may provide an approval 730 to have the service performed. Approval 730 may include, for example, selection of a particular service provider. Maintenance application server 140 may receive approval 730 and, as indicated by reference 740, may provide an order or appointment request to a maintenance service provider device 160 for the customer's selection. Maintenance service provider device 160 may process an order or schedule an appointment for the customer based on order/appointment request 740. In another implementation, order/appointment request 740 may initiate direct communications between maintenance service provider device 160 and user device 130 to process an order or schedule an appointment for the customer. Once an order is placed or an appointment is scheduled, maintenance service provider device 160 may provide a confirmation 750 to maintenance application server 140. Maintenance application server 140 may provide confirmation 750 to user device 130 and to customer/appliance database 150.

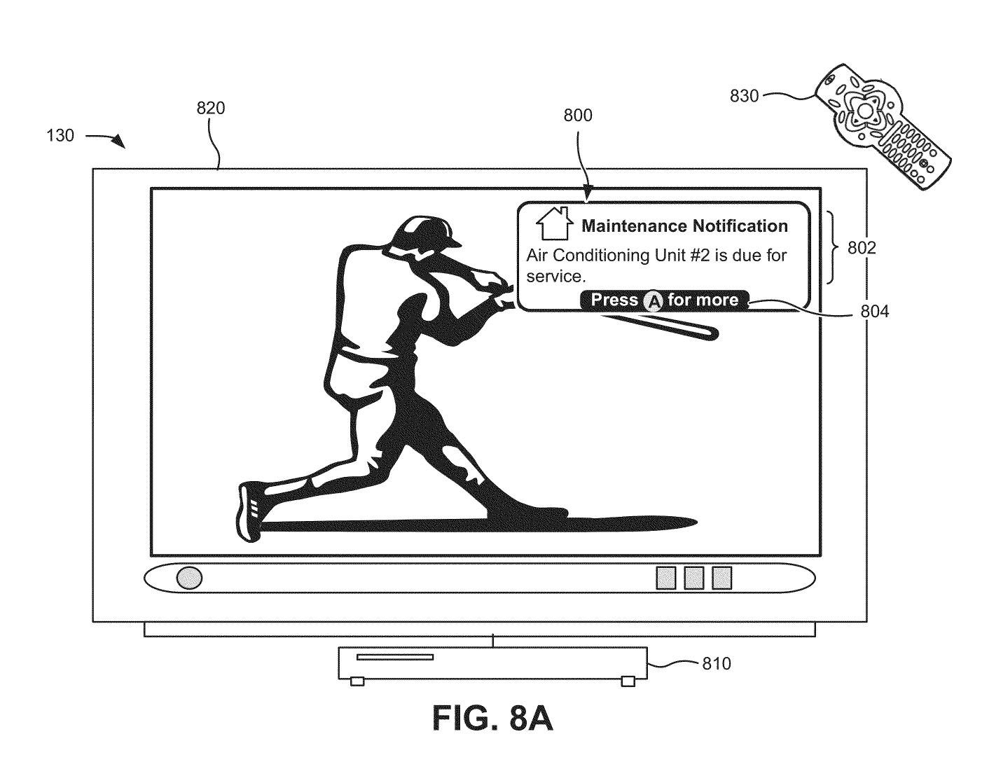

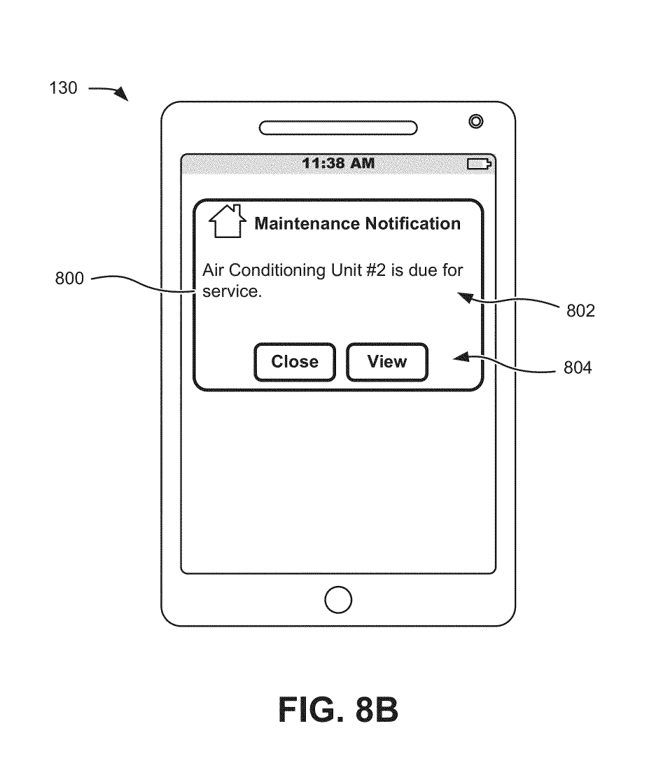

FIG. 8A and 8B provide exemplary user interfaces with for a service notification which may correspond to customer notification/offer 720. As shown in FIG. 8A, a notification window 800 may be presented on user device 130, when user device 130 includes a STB 810 and a television display 820. Notification window 800 may include, for example, a service description section 802 and a response section 804. Service description 802 may identify a particular appliance (e.g., a home appliance 120) and service due. Response section 804 may provide instructions for customer input. Customer input may include, for example, selecting additional information or closing notification window 800. To interact with notification window 800 in a STB/television format, a user may use a remote control 830 to respond prompts and/or provide instructions.

As shown in FIG. 8B, notification window 800 may be presented on user device 130, when user device 130 includes tablet computer. As presented on a tablet computer, notification window 800 may include the same or similar information as provided in the STB/television format. To interact with notification window 800 on a table computer, a user may use touch input.

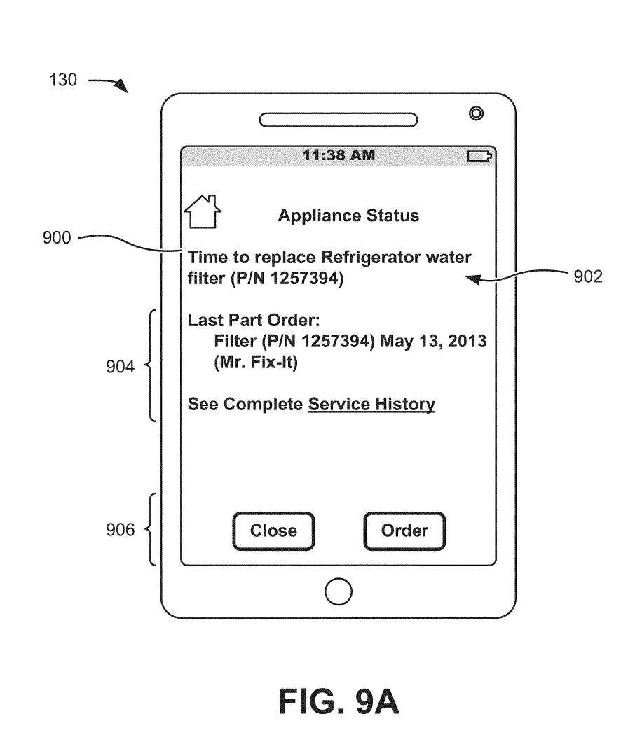

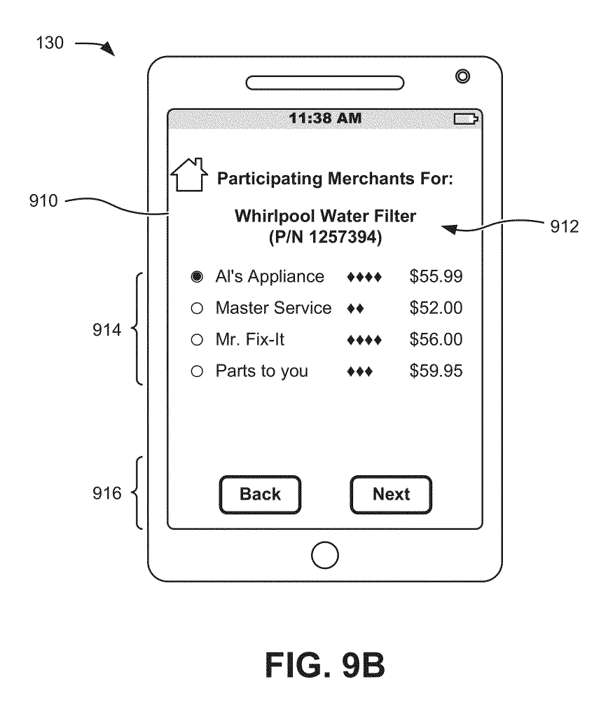

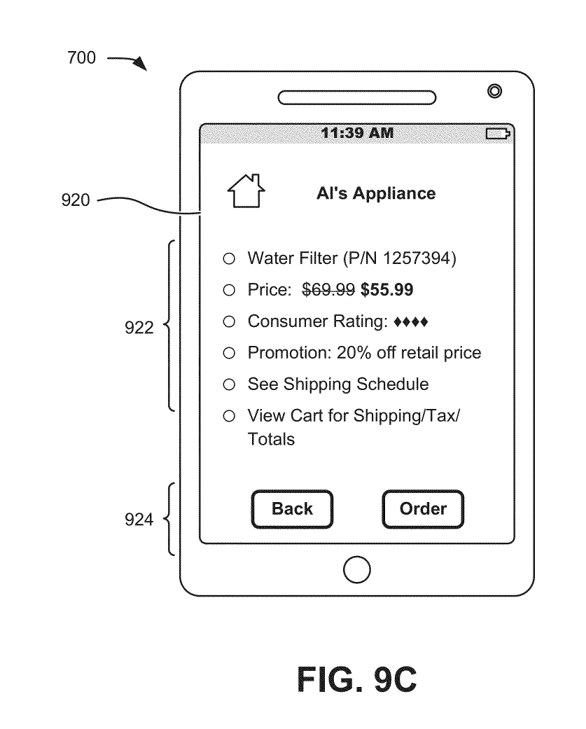

FIGS. 9A-9C provide exemplary user interfaces for responding to a service notification via user device 130. As shown in FIGS. 9A-9C, user interfaces may be presented on user device 130, when user device 130 includes tablet computer, in response to user input to notification window 800 (FIG. 8B). User interfaces for other forms of user device 130 may include similar information and/or formats to those shown in FIGS. 9A-9C.

Referring to FIG. 9A, when a customer elects to view details associated with notification window 800, user device 130 may present user interface window 900 with additional information (e.g., received from maintenance application server 140) that is relevant to the notification. User interface window 900 may include service details 902 and service history 904. Service details 902 may include, for example, details for the appliance service (e.g., for home appliance 120) that is required. Service details 902 may indicate a particular appliance, particular replacement parts, replacement part serial numbers, etc. Service history 904 may include a relevant summary related to the particular recommended service and/or a complete history of service activity for the particular home appliance 120. In one implementation, service history 904 may identify previous order information (e.g., dates, vendor, price, etc.) for parts and/or service. User interface window 900 may also include a user input section 906 to allow a user to cancel or proceed with ordering a related service or part.

Referring to FIG. 9B, assuming a user elects to proceed with an order from user input section 906, user device 130 may present user interface window 910 with available vendors and/or service providers (e.g., received from maintenance application server 140) that can provide the service indicated in notification window 800. In one implementation, user interface window 910 may include a service/part identification section 912 and ordering options 914. Service/part identification section 912 may indicate a particular appliance, particular replacement parts, replacement part serial numbers, etc. Order options 914 may include one or more vendors that are available (e.g., and registered with the home maintenance automation platform) to provide the part/service indicated in service/part identification section 912. Order options 914 may also include, for example, customer ratings for the vendor and prices for the part/service. In other implementations, different or additional vendor information may be included. User interface window 910 may also include a user input section 916 to allow a user to cancel or proceed with ordering the related service or part from a particular vendor.

As shown in FIG. 9C, assuming a user elects to proceed with a particular vendor from user order options 914, user device 130 may present user interface window 920 with order details for the particular vendor. User interface window 920 may include a details section 922 about a selected vendor (e.g., “Al's Appliance”) as applied to a particular part/service. For example, for a replacement part details section 922 may include a part name/serial number, a price, a consumer rating (e.g., based on post-transaction feedback), a coupon/discount description, shipping rates/schedule, tax, and total price. In another implementation, for a service call, details section 922 may include a service description, price, consumer rating, earliest appointment time, tax, and total price. User interface window 920 may also include a user input section 924 to allow a user to navigate to previous window or proceed with ordering the related service or part from the particular vendor.

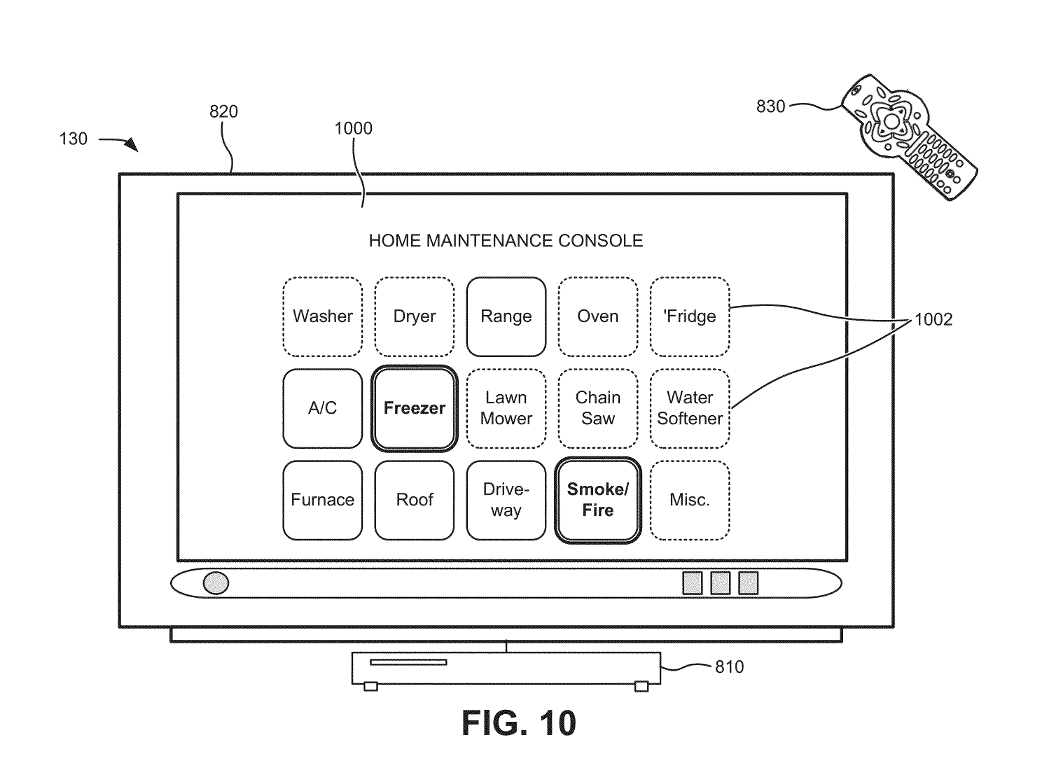

FIG. 10 provides an exemplary user interface for a home maintenance console, according to an implementation described herein. As shown in FIG. 10, a home menu 1000 may be presented on user device 130, when user device 130 includes STB 810 and television display 820. To interact with home menu 1000 in a STB/television format, a user may use remote control 830 to respond prompts and/or provide instructions. In other implementation, home menu 1000 may be presented in different configurations for other user devices 130.

Home menu 1000 may include, for example, a control panel for a grouping or list of appliances (or categories of appliance) registered to a particular customer as part of the home maintenance automation platform. In the configuration of FIG. 10, individual icons 1002 may be used to represent each appliance (e.g., each home appliance 120) and indicate the status of each appliance. In one implementation, each of icons 1002 may be color-coded or use other indications to represent the status of a corresponding appliance. The status of the appliance may include, in one example, an indicator of whether a maintenance action, relating to the particular appliance, is required by the user. For example, red or bold icons 1002 (e.g., “Freezer”) may indicate that immediate attention is needed; yellow or solid-outlined icons 1002 (e.g., “Range”) may indicate that the corresponding appliance needs maintenance/service in the near future; and green or dotted-outlined icons 1002 (e.g., “Washer”) may indicate that the maintenance/service schedule corresponding appliance is up to date. Thus, a status for each home appliance in home menu 1000 may be presented, in the context of the status of the other home appliances, by indicators included in in the respective icons 1002.

A user may select any one of icons 1002 (e.g., using remote control 830) to cause user device 130 to present additional information about a corresponding appliance. The additional information may include, for example, maintenance/service history for the appliance details of a needed service (if applicable), a future service schedule, etc. According to one implementation, user device 130 may communicate with smart appliances and/or a home security system to provide visual images (e.g., still or video images) of a particular appliance that corresponds to one of icons 1002.

Once a required action for a particular appliance is completed (e.g., installing a replacement part, perform service by a vendor, etc.), the appliance status may be updated using, for example, procedures described above with respect to FIGS. 3 and 6. As an example, a user may select a red icon 1002 for “Smoke/Fire,” causing user device 130 to present additional information indicating that a new battery is needed for a fire alarm. In one implementation, the user may replace the battery and manually indicate the status change (e.g., as battery replaced) via the user interface associated with the “Smoke/Fire” icon 1002. In another implementation, the user may replace the battery in the fire alarm and use mobile device 120 (with maintenance client application 300) to scan a barcode on the fire alarm unit to trigger a web service URL for maintenance application server 120. Through the URL, mobile device 120 can prompt the user to confirm that a new battery has been installed.

As another example, a user may select a yellow icon 1002 for “Furnace,” causing user device 130 to present additional information indicating that a seasonal inspection is due. The user may schedule a service call. The service technician may perform the service and use mobile device 120 (with maintenance client application 300) to scan a barcode on the furnace to trigger a web service URL for maintenance application server 140. Through the URL, mobile device 120 can prompt the service technician to confirm the seasonal service has been performed.

Assuming a successful maintenance procedure, maintenance application server 140 may provide user device 130 with updated status indications so that the particular icon 1002 associated with the service may be changed, for example, from a red or yellow color to green. In one implementation, maintenance application server 140 may update status information in real time. In another implementation, maintenance application server 140 may identify status updates during batch processing (e.g., batch processing 710 of FIG. 7) to identify that a scheduled maintenance event has been completed.

Although FIGS. 8A-10 depict a variety of user interfaces, in other implementations, these user interfaces may depict more, less, different and/or differently-arranged information than depicted in FIGS. 8A-10. In another implementation, interfaces similar to the user interfaces in FIGS. 8A-10 may be used to present information for the home maintenance automation platform on other types of user devices 130.

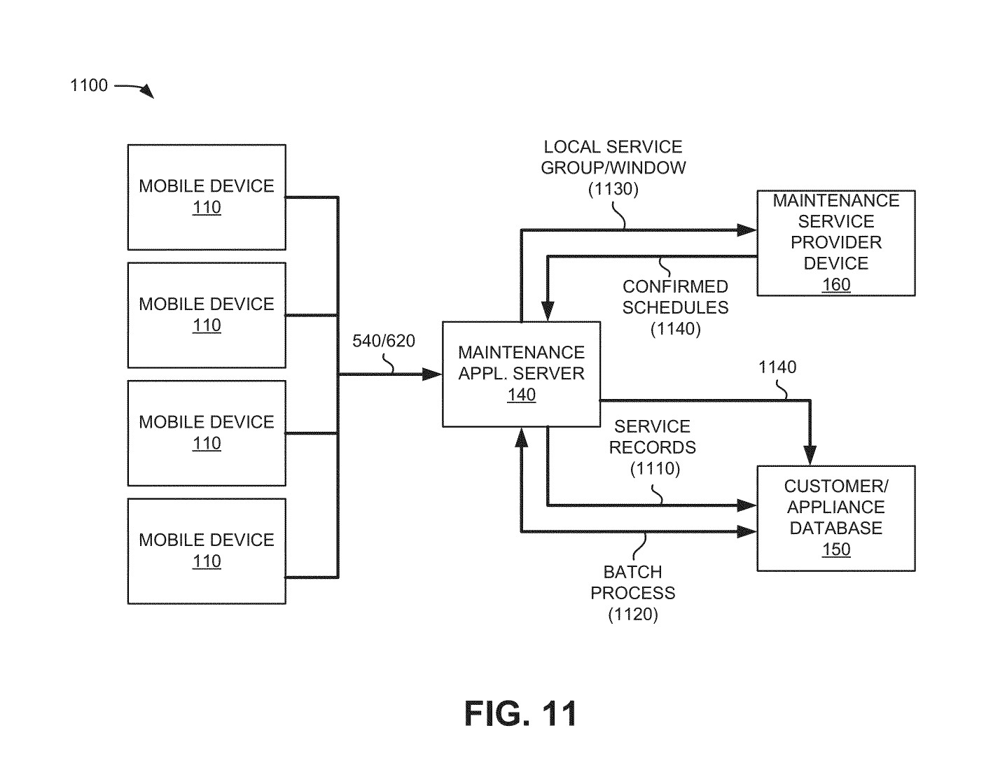

FIG. 11 is a diagram of exemplary communications among devices in another portion 1100 of network environment 100. Communications in FIG. 1 may represent communications for coordinating service schedules for within the home maintenance automation platform. As shown in FIG. 11, network portion 100 may include multiple mobile devices 110, maintenance application server 140, customer/appliance database 150, and maintenance service provider device 160. Mobile devices 110, maintenance application server 140, customer/appliance database 150, and maintenance service provider device 160 may include features described above in connection with, for example, FIGS. 1-7.

As shown in FIG. 11, mobile devices 110 may provide user identifier and appliance service information 540 (FIG. 5) and/or service information 620 (FIG. 6) to maintenance application server 140. Maintenance application server 140 may provide the user identifier and appliance service information 540 and/or service information 620 to customer/appliance database 150 as service records 1110. Maintenance application server 140 may conduct batch processing 1120 of data in customer/appliance database 150 to identify local customer groups and similar maintenance/service schedules for home appliances 120 at different customer locations.

According to one implementation, based on a batch process 1120, maintenance application server 140 may detect that scheduled maintenance events may be needed for multiple customers within a local area within the same timeframe. Maintenance application server 140 may identify one or more service providers available to service the local area (e.g., based on information from technician profile registration 420 (FIG. 4)). As indicated by reference 1130, maintenance application server 140 may provide the local service group and time window to maintenance service provider device 160. In one implementation, personal information in local service group/window 1130 may be kept anonymous until a service provider agrees to provide services. For example, maintenance application server 140 may provide an interface between maintenance service provider device 160 and user devices 130 (not shown) to facilitate service scheduling. In another implementation, customers may “opt-in” to allow necessary information to be provided to registered service providers. Thus, service providers may communicate directly with individual customers to coordinate service calls within the local service group.

Information in local service group/window 1130 may enable service providers to identify customers that require services in nearby areas. Local service group/window 1130 may allow service providers to save money and reduce the cost of services. In turn, the service providers can offer discounted services to customers in the local group. When a service call is confirmed, maintenance service provider device 160 may provide confirmed schedules 1140 to maintenance application server 140. Confirmed schedules 1140 may be sent to customer/appliance database 150 for eventual tracking, feedback, and/or follow-up.

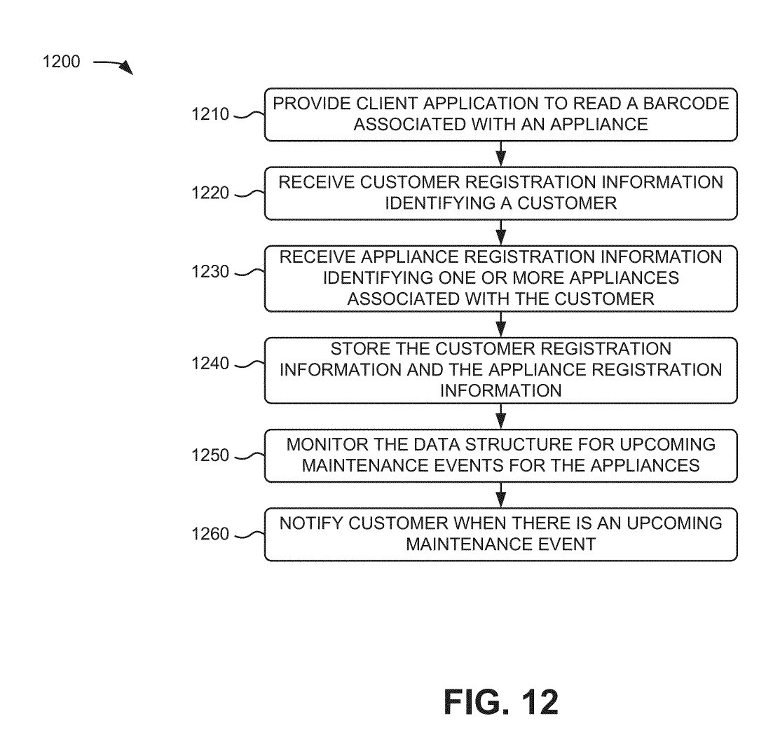

FIG. 12 is a flow diagram that illustrates an exemplary process 1200 for monitoring customer appliance service schedules in a home maintenance automation platform. In one implementation, process 1200 may be implemented by maintenance application server 140. In another implementation, process 1200 may be implemented by maintenance application server 140 in conjunction with one or more other devices (e.g., devices from network environment 100).

Process 1200 may include providing a client application to read a barcode associated with an appliance (block 1210), and receiving customer registration information identifying a customer (block 1220). For example, maintenance application server 140 may provide to mobile device 110 maintenance client application 300 that reads and/or interrogates barcodes (e.g., barcode 125), adds updated user profile and/or service information, and transmits barcode and updated information to a backend server (e.g., maintenance application server 140). Maintenance client application 300 may be provide, for example, as an application download via network 190. For registering as a customer, maintenance client application 300 may collect a customer name, home address, contact phone number(s), an email address, gender, age, etc. from a user. Mobile device 110 (e.g., using maintenance client application 300) may provide customer profile registration information to maintenance application server 140.

Process 1200 may further include receiving appliance registration information identifying one or more appliances associated with the customer (block 1230) and storing the customer registration information and the appliance registration information (block 1240). For example, mobile device 110 may perform a barcode scan of a home appliance 120 to receive a service schedule and other service information for the home appliance. Mobile device 110 may combine a user (or device) identifier with the appliance service information and provide the combined user identifier and appliance service information to maintenance application server 140. Maintenance application server 140 may send customer profile registration 410 to customer/appliance database 150 as part of compiled registration information 430. Maintenance application server 140 may also store customer service profile 550 in customer/appliance database 150.

Process 1200 may additionally include monitoring the data structure for upcoming maintenance events for the appliances (block 1250) and notifying the customer when there is an upcoming maintenance event (block 1260). For example, maintenance application server 140 may conduct batch processing 710 of data in customer/appliance database 150 to calculate and aggregate customer information and to provide customer health info about their home appliances 120. Based on a batch process 710, maintenance application server 140 may detect that a scheduled maintenance event may be applicable for a home appliance 120. Maintenance application server 140 may send a customer notification/offer 720 to a user device 130 associated with home appliance 120.

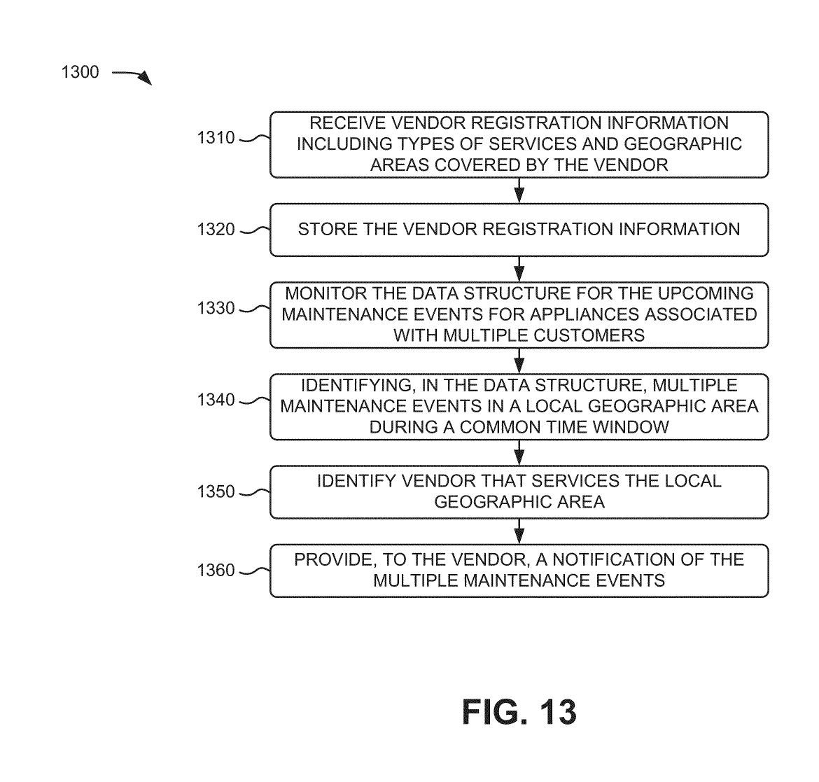

FIG. 13 is a flow diagram that illustrates an exemplary process 1300 for consolidating service calls in a home maintenance automation platform. In one implementation, process 1300 may be implemented by maintenance application server 140. In another implementation, process 1300 may be implemented by maintenance application server 140 in conjunction with one or more other devices (e.g., devices from network environment 100).

As shown in FIG. 13, process 1300 may include receiving vendor registration information including types of services and geographic areas covered by the vendor (block 1310) and storing the vendor registration information (block 1320). For example, for registering as a service provider, maintenance client application 300 may collect a company name, location address, locations served, technician contact information, etc. from a user. Mobile device 110 (e.g., using maintenance client application 300) may provide technician profile registration 420 to maintenance application server 140. In other implementation, a vendor may provide vendor registration information to maintenance application server 140 via a website interface. Maintenance application server 140 may send customer profile registration 410 to customer/appliance database 150 as part of compiled registration information 430.

Process 1300 may also include monitoring the data structure for the upcoming maintenance events for appliances associated with multiple customers (block 1330) and identifying, in the data structure, multiple maintenance events in a local geographic area during a common time window (block 1340). For example, maintenance application server 140 may conduct batch processing 1120 of data in customer/appliance database 150 to identify local customer groups and similar maintenance/service schedules for home appliances 120 at different customer locations. Based on a batch process 1120, maintenance application server 140 may detect that scheduled maintenance events may be needed for multiple customers within a local area within the same timeframe.

Process 1300 may further include identify a vendor that services the local geographic area (block 1350) and providing to the vendor a notification of the multiple maintenance events (block 1360). For example, maintenance application server 140 may identify one or more service providers available to service the local area (e.g., based on information from technician profile registration 420. Maintenance application server 140 may provide the local service group and time window to one or more corresponding maintenance service provider device 160.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks have been described with regard to FIGS. 12 and 13, the order of the blocks may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device, customer registration information identifying a customer;
receiving, by the network device, first appliance registration information identifying a first appliance associated with the customer, wherein the first appliance registration information includes an initiation date and a service schedule of maintenance events for the first appliance;
receiving, by the network device, second appliance registration information identifying a second appliance associated with the customer, wherein the second appliance registration information includes an initiation date and a service schedule of maintenance events for the second appliance;
storing, in a data structure and by the network device, the customer registration information, the first appliance registration information, and the second appliance registration information; and
monitoring, by the network device, the data structure for upcoming maintenance events for the first appliance or the second appliance.

2. The method of claim 1, further comprising:
providing, by the network device and using the customer registration information, a notification to a customer when the monitoring detects an upcoming maintenance event for the first appliance or the second appliance.

3. The method of claim 2, wherein the notification includes one or more of:
a text message,
an email message,
a television pop-up notification, or
a notification via a mobile application.

4. The method of claim 2, wherein the notification includes:
a list of one or more vendors from which a part, associated with the upcoming maintenance event, can be purchased; or
a list of one or more vendors for performing a service call associated with the upcoming maintenance event.

5. The method of claim 1, wherein the upcoming maintenance events for the first appliance or the second appliance include one or more of:
replacing of a part associated with the first appliance or the second appliance, or performing a service procedure or inspection for the first appliance or the second appliance.

6. The method of claim 1, further comprising:
monitoring the data structure for the upcoming maintenance events for appliances associated with multiple customers;
identifying, in the data structure, multiple maintenance events in a local geographic area during a common time window; and
providing, to a vendor, a notification of the multiple maintenance events.

7. The method of claim 6, further comprising:
receiving vendor registration information including types of services and geographic areas covered by the vendor; and
storing, in the data structure, the vendor registration information.

8. The method of claim 1, further comprising:
receiving, from a mobile device, an indication of a service that was performed on the first appliance or the second appliance; and
storing, in the data structure, the indication of the service with the customer registration information, the first appliance registration information, and the second appliance registration information.

9. The method of claim 1, further comprising:
receiving, from a user device, a request for data to present an appliance control panel;
providing, to the user device:
a current status of the first appliance in relation to the initiation date and the service schedule of maintenance events for the first appliance, and
a current status of the second appliance in relation to the initiation date and the service schedule of maintenance events for the second appliance.

10. The method of claim 9, wherein the current status of the first appliance and the current status of the second appliance each include an indication of whether action, relating to the respective first appliance or second appliance, is required by the user, and
wherein the current status of the first appliance and the current status of the second appliance is indicated within the appliance control panel among a status of other appliances.

11. The method of claim 1, further comprising:
sending, to a mobile device, a client application to read a barcode associated with the first appliance, wherein the barcode includes an identifier for the first appliance and a uniform resource locator (URL) to obtain the service schedule of maintenance events for the first appliance.

12. A device, comprising:
a memory configured to store a plurality of instructions; and
a processing unit configured to:
receive customer registration information identifying a customer,
receive first appliance registration information identifying a first appliance associated with the customer, wherein the first appliance registration information includes an initiation date and a service schedule of maintenance events for the first appliance,
receive second appliance registration information identifying a second appliance associated with the customer, wherein the second appliance registration information includes an initiation date and a service schedule of maintenance events for the second appliance,
store, in a data structure, the customer registration information, the first appliance registration information, and the second appliance registration information, and
monitor the data structure for upcoming maintenance events for the first appliance or the second appliance.

13. The device of claim 12, wherein the processing unit is further configured to:
provide, using the customer registration information, a notification to a customer when the monitoring detects an upcoming maintenance event for the first appliance or the second appliance.

14. The device of claim 12, wherein the notification includes:
a list of one or more vendors from which a part, associated with the upcoming maintenance event, can be purchased; or
a list of one or more vendors for performing a service call associated with the upcoming maintenance event.

15. The device of claim 12, wherein the processing unit is further configured to:
receive, from an appliance manufacturer device, updated service schedule information for one or more of the first appliance or the second appliance, and
store, in the data structure, the updated service schedule information associated with the customer.

16. The device of claim 12, wherein the processing unit is further configured to:
monitor the data structure for the upcoming maintenance events for appliances associated with multiple customers,
identify, in the data structure, multiple maintenance events in a local geographic area during a common time window, and
provide, to a vendor, a notification of the multiple maintenance events.

17. The device of claim 12, wherein the processing unit is further configured to:
send, to a mobile device, a client application configured to read a barcode associated with the first appliance, wherein the barcode includes a uniform resource locator (URL) to obtain the service schedule of maintenance events for the first appliance.

18. A computer-readable medium containing instructions executable by at least one processing unit, the computer-readable medium comprising one or more instructions for:
receiving customer registration information identifying a customer;
receiving first appliance registration information identifying a first appliance associated with the customer, wherein the first appliance registration information includes an initiation date and a service schedule of maintenance events for the first appliance;
receiving second appliance registration information identifying a second appliance associated with the customer, wherein the second appliance registration information includes an initiation date and a service schedule of maintenance events for the second appliance;
storing, in a data structure, the customer registration information, the first appliance registration information, and the second appliance registration information; and
monitoring the data structure for upcoming maintenance events for the first appliance or the second appliance.

19. The computer-readable medium claim 18, further comprising one or more instructions for:
monitoring the data structure for the upcoming maintenance events for appliances associated with multiple customers;
identifying, in the data structure, multiple maintenance events in a local geographic area during a common time window; and
providing, to a vendor device, a notification of the multiple maintenance events.

20. The computer-readable medium claim 18, further comprising one or more instructions for:
receiving, from a mobile device, an indication of a service that was performed on the first appliance or the second appliance; and
storing, in the data structure, the indication of the service with the customer registration information, the first appliance registration information, and the second appliance registration information.
